(19) United States
(12) Patent Application Publication
(10) Pub. No.: US 2020/0311756 A1
(43) Pub. Date: Oct. 1, 2020

(54) APPARATUS, METHOD, AND PROGRAM PRODUCT FOR REWARDING A USER THAT COMPLETES A TASK

(71) Applicant: LENOVO (Singapore) PTE. LTD., New Tech Park (SG)

(72) Inventors: Kevin Wayne Beck, Raleigh, NC (US); Russell Speight VanBlon, Raleigh, NC (US); Thorsten Peter Stremlau, Morrisville, NC (US)

(21) Appl. No.: 16/367,220

(22) Filed: Mar. 27, 2019

(51) Int. Cl. G06Q 30/02; G06F 11/34; G09B 5/00

(52) U.S. Cl. CPC G06Q 30/0215; G09B 5/00; G06F 11/3438

(57) ABSTRACT

Apparatuses, methods, and program products are disclosed for rewarding a user that completes a task. One apparatus includes a processor and a memory that stores code executable by the processor. The code is executable by the processor to determine, by use of a sensor, whether a task is completed correctly. The code is executable by the processor to, in response to determining that the task is completed correctly: determine a user corresponding to the task; change an account corresponding to the user to indicate that the task is completed correctly; and reward the user.

### BACKGROUND

### Field

The subject matter disclosed herein relates to task completion and more particularly relates to rewarding a user that completes a task.

### Description of the Related Art

Information handling devices, such as desktop computers, laptop computers, tablet computers, smart phones, optical head-mounted display units, smart watches, televisions, streaming devices, etc., are ubiquitous in society. These information handling devices may be used for performing various actions. For example, an information handling device may be used to provide information to a user.

### BRIEF SUMMARY

An apparatus for rewarding a user that completes a task is disclosed. A method and computer program product also perform the functions of the apparatus. In one embodiment, the apparatus includes a processor and a memory that stores code executable by the processor. The code, in various embodiments, is executable by the processor to determine, by use of a sensor, whether a task is completed correctly. The code, in certain embodiments, is executable by the processor to, in response to determining that the task is completed correctly: determine a user corresponding to the task; change an account corresponding to the user to indicate that the task is completed correctly; and reward the user.

In some embodiments, the sensor includes a camera, a microphone, a photosensor, a temperature sensor, a gyroscope, a meter, a switch, a proximity switch, a mechanical switch, an optical detector, or some combination thereof. In one embodiment, the task includes a household task selected from a group including cleaning a room, organizing the room, vacuuming the room, turning off a light, turning on the light, closing a door, opening the door, closing a window, opening the window, washing dishes, putting the dishes in a dishwasher, unloading the dishes from the dishwasher, feeding an animal, providing water to the animal, cleaning up after the animal, washing a car, vacuuming the car, cleaning the car, mowing a lawn, edging the lawn, shoveling snow, organizing a bookshelf, putting away toys, flushing a toilet, turning off an electronic device, turning on the electronic device, washing laundry, drying the laundry, and folding the laundry.

In various embodiments, rewarding the user includes rewarding the user with an audible sound, a financial award, a prize, points, electronic usage time, an outing, or some combination thereof. In some embodiments, the code executable by the processor, in response to determining that the task is not completed correctly, provides an audible response to the user to indicate that the task is not completed correctly.

A method for rewarding a user that completes a task, in one embodiment, includes determining, by use of a sensor, whether a task is completed correctly. In certain embodiments, the method includes, in response to determining that the task is completed correctly: determining a user corresponding to the task; changing an account corresponding to the user to indicate that the task is completed correctly; and rewarding the user.

In some embodiments, the sensor includes a camera, a microphone, a photosensor, a temperature sensor, a gyroscope, a meter, a switch, a proximity switch, a mechanical switch, an optical detector, or some combination thereof. In various embodiments, the task includes a household task selected from a group including cleaning a room, organizing the room, vacuuming the room, turning off a light, turning on the light, closing a door, opening the door, closing a window, opening the window, washing dishes, putting the dishes in a dishwasher, unloading the dishes from the dishwasher, feeding an animal, providing water to the animal, cleaning up after the animal, washing a car, vacuuming the car, cleaning the car, mowing a lawn, edging the lawn, shoveling snow, organizing a bookshelf, putting away toys, flushing a toilet, turning off an electronic device, turning on the electronic device, washing laundry, drying the laundry, and folding the laundry.

In one embodiment, determining whether the task is completed correctly includes detecting by use of the sensor and without human intervention that the task is completed correctly. In some embodiments, determining whether the task is completed correctly includes detecting using multiple sensors that the task is completed correctly. In certain embodiments, determining whether the task is completed correctly includes analyzing an image obtained by the sensor to determine whether the task is completed correctly.

In some embodiments, rewarding the user includes rewarding the user with an audible sound, a financial award, a prize, points, electronic usage time, an outing, or some combination thereof. In various embodiments, the method includes, in response to determining that the task is not completed correctly, providing an audible response to the user to indicate that the task is not completed correctly. In certain embodiments, the method includes, in response to determining that the task is not completed correctly, providing training to the user to teach the user how to complete the task correctly.

In one embodiment, a program product includes a computer readable storage medium that stores code executable by a processor. The executable code, in certain embodiments, includes code to perform determining, by use of a sensor, whether a task is completed correctly. The executable code, in various embodiments, includes code to perform, in response to determining that the task is completed correctly: determining a user corresponding to the task; changing an account corresponding to the user to indicate that the task is completed correctly; and rewarding the user.

In certain embodiments, the executable code further includes code to perform determining whether the task is completed correctly by detecting by use of the sensor and without human intervention that the task is completed correctly.

In one embodiment, the executable code further includes code to perform determining whether the task is completed correctly by detecting using multiple sensors that the task is completed correctly. In certain embodiments, the executable code further includes code to perform determining whether the task is completed correctly by analyzing an image obtained by the sensor to determine whether the task is completed correctly.

In various embodiments, the executable code further includes code to perform, in response to determining that the task is not completed correctly, providing an audible response to the user to indicate that the task is not completed correctly. In some embodiments, the executable code further includes code to perform, in response to determining that the task is not completed correctly, providing training to the user to teach the user how to complete the task correctly.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for rewarding a user that completes a task;

FIG. 2 is a schematic block diagram illustrating one embodiment of an apparatus including an information handling device;

FIG. 3 is a schematic block diagram illustrating one embodiment of an apparatus including a task motivation module;

FIG. 4 is a schematic block diagram illustrating another embodiment of an apparatus including a task motivation module;

FIG. 5 is a schematic flow chart diagram illustrating an embodiment of a method for rewarding a user that completes a task; and

FIG. 6 is a schematic flow chart diagram illustrating another embodiment of a method for rewarding a user that completes a task.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification have been labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

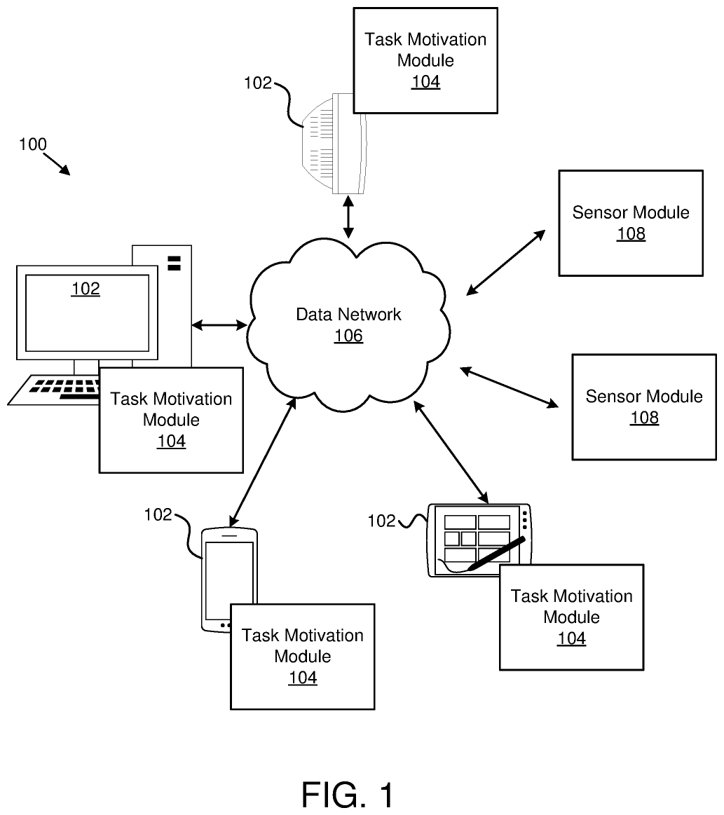

FIG. 1 depicts one embodiment of a system 100 for rewarding a user that completes a task. In one embodiment, the system 100 includes information handling devices 102, task motivation modules 104, data networks 106, and sensor modules 108. Even though a specific number of information handling devices 102, task motivation modules 104, data networks 106, and sensor modules 108 are depicted in FIG. 1, one of skill in the art will recognize that any number of information handling devices 102, task motivation modules 104, data networks 106, and sensor modules 108 may be included in the system 100.

In one embodiment, the information handling devices 102 include computing devices, such as desktop computers, laptop computers, personal digital assistants (PDAs), tablet computers, smart phones, cellular phones, smart televisions (e.g., televisions connected to the Internet), set-top boxes, game consoles, security systems (including security cameras), vehicle on-board computers, network devices (e.g., routers, switches, modems), streaming devices, or the like. In some embodiments, the information handling devices 102 include wearable devices, such as smart watches, fitness bands, optical head-mounted displays, or the like. The information handling devices 102 may access the data network 106 directly using a network connection.

The information handling devices 102 may include an embodiment of the task motivation module 104. In certain embodiments, the task motivation module 104 may determine, by use of a sensor (e.g., one or more sensor modules 108), whether a task is completed correctly. The task motivation module 104 may also, in response to determining that the task is completed correctly: determine a user corresponding to the task; change an account corresponding to the user to indicate that the task is completed correctly; and reward the user. In this manner, the task motivation module 104 may be used for rewarding a user that completes a task.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a WAN, a storage area network (“SAN”), a LAN, an optical fiber network, the internet, or other digital communication network. The data network 106 may include two or more networks. The data network 106 may include one or more servers, routers, switches, and/or other networking equipment. The data network 106 may also include computer readable storage media, such as a hard disk drive, an optical drive, non-volatile memory, RAM, or the like.

The sensor module 108 may include any suitable type of sensor used to determine whether a task is completed correctly. For example, the sensor module 108 may include one or more sensors. As another example, the sensor module 108, or a sensor of the sensor module, may include a camera, a microphone, a photosensor, a temperature sensor, a gyroscope, a meter, a switch, a proximity switch, a mechanical switch, a position sensor, and/or an optical detector.

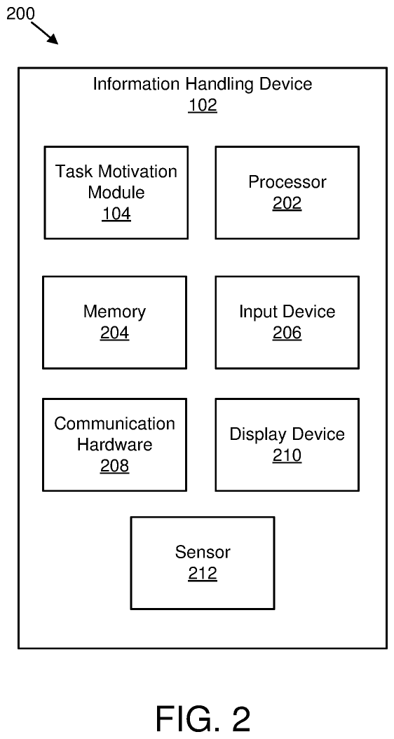

FIG. 2 depicts one embodiment of an apparatus 200 that may be used for rewarding a user that completes a task. The apparatus 200 includes one embodiment of the information handling device 102. Furthermore, the information handling device 102 may include the task motivation module 104, a processor 202, a memory 204, an input device 206, communication hardware 208, a display device 210, and a sensor 212. In some embodiments, the input device 206 and the display device 210 are combined into a single device, such as a touchscreen.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the task motivation module 104, the input device 206, the communication hardware 208, the display device 210, and the sensor 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media.

In some embodiments, the memory 204 stores data relating to rewarding a user that completes a task. In some embodiments, the memory 204 also stores program code and related data, such as an operating system or other controller algorithms operating on the information handling device 102.

The information handling device 102 may use the task motivation module 104 for rewarding a user that completes a task. As may be appreciated, the task motivation module 104 may include computer hardware, computer software, or a combination of both computer hardware and computer software. For example, the task motivation module 104 may include circuitry, or a processor, used to determine, by use of a sensor (e.g., the sensor 212 and/or the sensor module 108), whether a task is completed correctly. As another example, the task motivation module 104 may include computer program code that, in response to determining that the task is completed correctly: determines a user corresponding to the task; changes an account corresponding to the user to indicate that the task is completed correctly; and rewards the user.

The input device 206, in one embodiment, may include any known computer input device including a touch panel, a button, a keyboard, a stylus, or the like. In some embodiments, the input device 206 may be integrated with the display device 210, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel. The communication hardware 208 may facilitate communication with other devices. For example, the communication hardware 208 may enable communication via Bluetooth®, Wi-Fi, and so forth.

The display device 210, in one embodiment, may include any known electronically controllable display or display device. The display device 210 may be designed to output visual, audible, and/or haptic signals. In some embodiments, the display device 210 includes an electronic display capable of outputting visual data to a user. For example, the display device 210 may include, but is not limited to, an LCD display, an LED display, an OLED display, a projector, or similar display device capable of outputting images, text, or the like to a user. As another, non-limiting, example, the display device 210 may include a wearable display such as a smart watch, smart glasses, a heads-up display, or the like. Further, the display device 210 may be a component of a smart phone, a personal digital assistant, a television, a table computer, a notebook (laptop) computer, a personal computer, a vehicle dashboard, a streaming device, or the like.

In certain embodiments, the display device 210 includes one or more speakers for producing sound. For example, the display device 210 may produce an audible alert or notification (e.g., a beep or chime). In some embodiments, the display device 210 includes one or more haptic devices for producing vibrations, motion, or other haptic feedback. For example, the display device 210 may produce haptic feedback upon performing an action.

In some embodiments, all or portions of the display device 210 may be integrated with the input device 206. For example, the input device 206 and display device 210 may form a touchscreen or similar touch-sensitive display. In other embodiments, the display device 210 may be located near the input device 206. In certain embodiments, the display device 210 may receive instructions and/or data for output from the processor 202 and/or the task motivation module 104.

The sensor 212 may be any suitable type of sensor that can determine whether a task is completed correctly. For example, the sensor 212 may include a camera, a microphone, a photosensor, a temperature sensor, a gyroscope, a meter, a switch, a proximity switch, a mechanical switch, a position sensor, an optical detector, and/or the like.

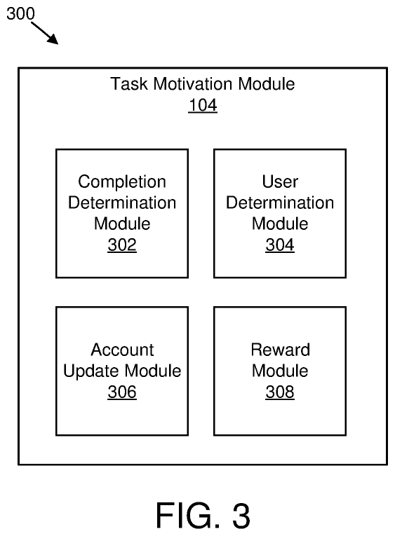

FIG. 3 depicts a schematic block diagram illustrating one embodiment of an apparatus 300 that includes one embodiment of the task motivation module 104. Furthermore, the task motivation module 104 includes a completion determination module 302, a user determination module 304, an account update module 306, and a reward module 308.

In certain embodiments, the completion determination module 302 may determine, by use of at least one sensor (e.g., one or more sensor modules 108 and/or one or more sensors 212), whether a task is completed correctly. The at least one sensor may include any suitable sensor that can be used to determine whether a task is completed correctly. For example, the at least one sensor may include a camera, a microphone, a photosensor, a temperature sensor, a gyroscope, a meter, a switch, a proximity switch, a mechanical switch, a position sensor, an optical detector, an internet-of-things (“IoT”) device, and/or the like.

The task may include any suitable task (e.g., physical task, chore) that is completed and/or for which determination of completion may be detected by a sensor. For example, the task may include a household task (e.g., a task completed in and/or at a house) such as compliance with instructed behavior, cleaning a room, organizing the room (e.g., straightening up), vacuuming the room, turning off a light (e.g., in a room that is to be unoccupied), turning on the light, closing a door, opening the door, closing a window, opening the window, washing dishes, putting the dishes in a dishwasher, unloading the dishes from the dishwasher, feeding an animal, providing water to the animal, cleaning up after the animal, washing a car, vacuuming the car, cleaning the car, mowing a lawn, edging the lawn, shoveling snow, organizing a bookshelf, putting away toys, flushing a toilet, turning off an electronic device, turning on the electronic device, washing laundry, drying the laundry, folding the laundry, and/or the like.

In one example, the completion determination module 302 may determine that a task is completed by sensing (e.g., using a microphone) an instructed behavior, and by sensing that the instructed behavior is completed correctly. In another example, the completion determination module 302 may determine that a room (e.g., or car, bookshelf, toy area, etc.) is cleaned, organized, and/or vacuumed (e.g., a task) by: comparing a picture of the room before the task is completed to a picture of the room after the task is completed; detecting actions in the room that indicate that the task is being completed; detecting a power usage signal indicating that a vacuum is used over a period of time; detecting movement of a vacuum across a floor of the room; detecting whether items in the room are in a correct place; and so forth.

In a further example, the completion determination module 302 may determine that a light is turned on, the light is turned off, an electronic device is turned off, the electronic device is turned on, laundry is washed, laundry is dried, and so forth by: using an electric meter to detect power usage of a specific light or device; using a microphone to detect a sound made by the device; using a photosensor to detect light; observing the action using a camera (e.g., video camera); and so forth. In an additional example, the completion determination module 302 may determine that a door is closed, the door is opened, a window is closed, the window is opened, a toilet is flushed by: detecting a sound made by such an action; observing the action using a camera (e.g., video camera); using a switch to detect whether an object is opened or closed; and so forth.

Various examples are provided herein to describe certain ways that one or more sensors can be used to detect the completion of tasks. It should be noted that these are merely examples and any suitable method for detecting the completion of tasks may be used. Moreover, artificial intelligence may be used to detect patterns that occur if the task is completed correctly compared to patterns that occur if the task is not completed correctly. In addition, the completion determination module 302 may learn over time more, different, and/or improved methods for detecting whether a task is completed correctly. As may be appreciated, a task being completed correctly may mean that the task is completed based on a verbal instruction, based on a desired outcome, based on predetermined rules, based on predetermined criteria, and so forth.

In some embodiments, the completion determination module 302 determining whether the task is completed correctly may include detecting by use of the sensor and without human intervention that the task is completed correctly. In other words, the completion determination module 302 may not need any user input and/or feedback to determine that the task is completed correctly.

In certain embodiments, the completion determination module 302 determining whether the task is completed correctly may include detecting using multiple sensors that the task is completed correctly. The multiple sensors may include one or more sensor modules 108 and/or one or more sensors 212.

In various embodiments, the completion determination module 302 determining whether the task is completed correctly may include analyzing an image obtained by the sensor (e.g., a camera, a video camera, etc.) to determine whether the task is completed correctly. As may be appreciated, the image may be analyzed to determine whether a light is on or off, whether items in the image are in a correct place, whether the area in the image is clean, and so forth.

In one embodiment, the user determination module 304 may, in response to determining that the task is completed correctly, determine a user corresponding to the task. The user may be a person assigned to complete the task and/or a person that actually completed the task. The user determination module 304 may determine the user by: the user providing an indication to the user determination module 304 to indicate that the user is associated with the task; the user providing an indication to the user determination module 304 to indicate that the user completed the task; using one or more sensors to detect that the user actually completed the task; accessing a database that indicates that the user is assigned to complete the task; and so forth.

In various embodiments, the account update module 306 may, in response to determining that the task is completed correctly, change an account corresponding to the user to indicate that the task is completed correctly. For example, the user may have an account that lists tasks corresponding to the user and indicates whether a task is completed correctly at least one time during a predetermined time period. The account may store a correspondence between the task being completed correctly and the predetermined time period so that the task completion can be tracked over time. As an example, a user may be assigned a task of cleaning their room each week. The account may store information for each week that indicates whether the room is cleaned for that particular week. Accordingly, the account update module 306 may change the account corresponding to the user to indicate that the room is cleaned at least one time during the predetermined time period (e.g., week).

In certain embodiments, the reward module 308 may, in response to determining that the task is completed correctly, reward the user. The reward may be any suitable reward and/or the reward may correspond to the task completed. For example, the reward module 308 may reward the user with an audible sound, a financial award (e.g., a gift card, money deposited in an account, money transferred to an account), a prize, points, electronic usage time (e.g., internet time, computer time, television viewing time, game device time), an outing (e.g., a trip to the store, a sporting event, an amusement park, an amusement place, a zoo, an arcade, roller skating, ice skating, skiing, a movie, eating out, and so forth), and/or the like. The reward may be incremental over time such that completion of a task gives a certain portion of a reward that corresponds to the task completed. In some embodiments, the electronic usage time may be metered and/or controlled by a home router, a software, and/or an access point that may be directly linked to the reward module 308. In various embodiments, the audible sound may be a verbal encouragement indicating successful completion of the task and/or an acknowledgement of successful completion of the task. The audible sound may be provided through an electronic device, a portable speaker, an IoT device, a smart speaker, and/or the like. In one example, the audible sound may produce comments such as “thank you for cleaning up,” “thank you for turning off the lights,” and so forth.

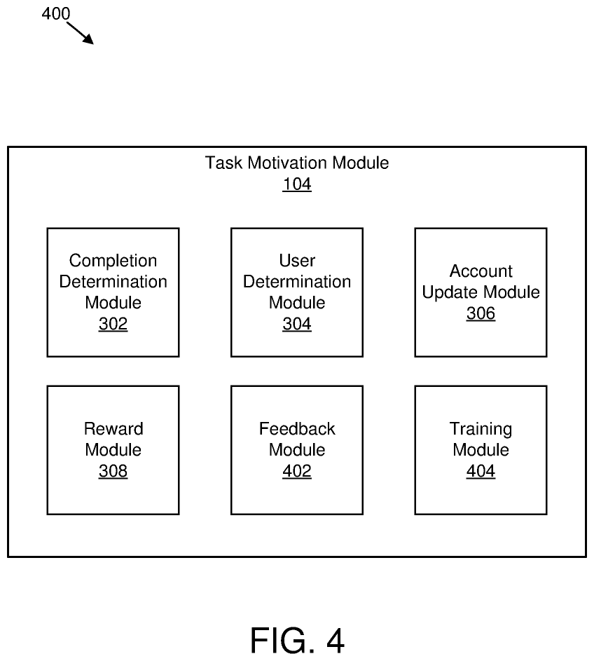

FIG. 4 is a schematic block diagram illustrating another embodiment of an apparatus 400 that includes one embodiment of the task motivation module 104. Furthermore, the task motivation module 104 includes one embodiment of the completion determination module 302, the user determination module 304, the account update module 306, and the reward module 308, that may be substantially similar to the completion determination module 302, the user determination module 304, the account update module 306, and the reward module 308 described in relation to FIG. 3. The task motivation module 104 also includes a feedback module 402 and a training module 404.

In some embodiments, the feedback module 402 may, in response to determining that the task is not completed correctly, provide an audible response to the user to indicate that the task is not completed correctly. The audible response may provide information that indicates why the task is not completed correctly, information that indicates how to complete the task correctly, encouragement for the user to keep trying, a reminder to complete the task, specific locations for the user to look to complete the task correctly, steps that the user has not completed, and so forth. The audible response may be provided through an electronic device, a portable speaker, an IoT device, a smart speaker, and/or the like. The feedback module 402 may detect when the correct user assigned to the task is present near a device used to provide the audible response before the feedback module 402 provides the audible response to facilitate the user actually hearing the audible response.

In certain embodiments, the training module 404 may, in response to determining that the task is not completed correctly, provide training to the user to teach the user how to complete the task correctly. The training may include audible training and/or visual training. For example, the training may include instructions (e.g., steps) for how to complete the task, a video that shows how to complete the task, a video that shows how to complete a portion of the task, and so forth. The training module 404 may detect a portion of the task that is not completed correctly and provide training corresponding to the portion of the task to facilitate the user completing the task correctly.

In some embodiments, the task motivation module 104 may have been initially provided and/or trained with a desired end state (e.g., what a properly cleaned and/or arranged room looks like, a proper placement of items and/or dishes, etc.), then a user working on the task may query the task motivation module 104 for information regarding a placement and/or location to put an item, and the training module 404 may provide audible training and/or visual training to instruct the user on proper placement of the item. For example, a user may ask “where does this go?” and the training module 404 may provide training to instruct the user where the item goes. As may be appreciated, a sensor may detect what item the user is asking about.

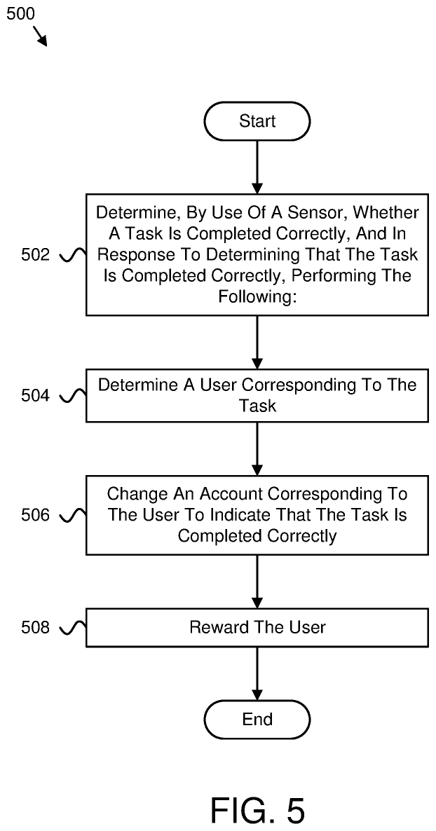

FIG. 5 is a schematic flow chart diagram illustrating an embodiment of a method 500 for rewarding a user that completes a task. In some embodiments, the method 500 is performed by an apparatus, such as the information handling device 102. In other embodiments, the method 500 may be performed by a module, such as the task motivation module 104. In certain embodiments, the method 500 may be performed by a processor executing program code, for example, a microcontroller, a microprocessor, a CPU, a GPU, an auxiliary processing unit, a FPGA, or the like.

The method 500 may include determining 502, by use of a sensor (e.g., the sensor module 108, the sensor 212), whether a task is completed correctly. In certain embodiments, the completion determination module 302 may determine 502 whether the task is completed correctly. The method 500 may perform elements 504, 506, and 508 in response to determining that the task is completed correctly.

In some embodiments, determining 502 whether the task is completed correctly includes detecting by use of the sensor and without human intervention that the task is completed correctly. In various embodiments, determining 502 whether the task is completed correctly includes detecting using multiple sensors that the task is completed correctly. In certain embodiments, determining 502 whether the task is completed correctly includes analyzing an image obtained by the sensor to determine whether the task is completed correctly.

The sensor may include a camera, a microphone, a photosensor, a temperature sensor, a gyroscope, a meter, a switch, a proximity switch, a mechanical switch, a position sensor, and/or an optical detector. The task may include a household task such as cleaning a room, organizing the room, vacuuming the room, turning off a light, turning on the light, closing a door, opening the door, closing a window, opening the window, washing dishes, putting the dishes in a dishwasher, unloading the dishes from the dishwasher, feeding an animal, providing water to the animal, cleaning up after the animal, washing a car, vacuuming the car, cleaning the car, mowing a lawn, edging the lawn, shoveling snow, organizing a bookshelf, putting away toys, flushing a toilet, turning off an electronic device, turning on the electronic device, washing laundry, drying the laundry, and/or folding the laundry.

The method 500 may include determining 504 a user corresponding to the task. In some embodiments, the user determination module 304 may determine 504 the user corresponding to the task.

The method 500 may include changing 506 an account corresponding to the user to indicate that the task is completed correctly. In some embodiments, the account update module 306 may change 506 the account corresponding to the user to indicate that the task is completed correctly.

The method 500 may include rewarding 508 the user, and the method 500 may end. In some embodiments, the reward module 308 may reward 508 the user. In certain embodiments, rewarding 508 the user includes rewarding the user with an audible sound, a financial award, a prize, points, electronic usage time, an outing, and/or the like.

In some embodiments, the method 500 includes, in response to determining that the task is not completed correctly, providing an audible response to the user to indicate that the task is not completed correctly. In various embodiments, the method 500 includes, in response to determining that the task is not completed correctly, providing training to the user to teach the user how to complete the task correctly.

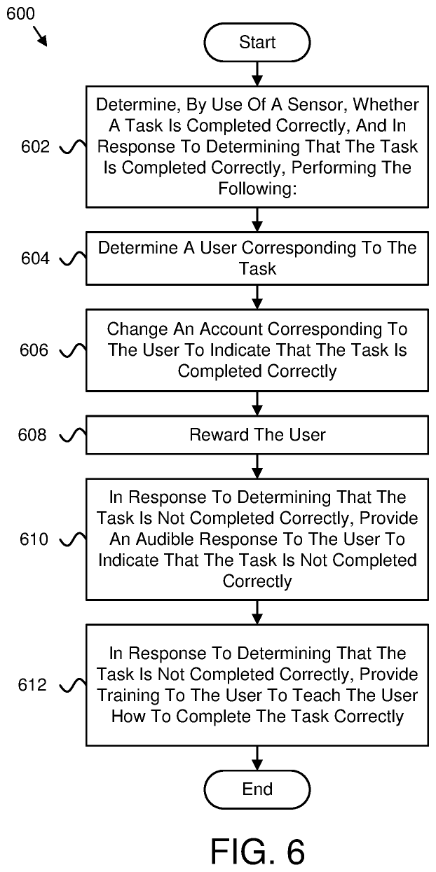

FIG. 6 is a schematic flow chart diagram illustrating another embodiment of a method 600 for rewarding a user that completes a task. In some embodiments, the method 600 is performed by an apparatus, such as the information handling device 102. In other embodiments, the method 600 may be performed by a module, such as the task motivation module 104. In certain embodiments, the method 600 may be performed by a processor executing program code, for example, a microcontroller, a microprocessor, a CPU, a GPU, an auxiliary processing unit, a FPGA, or the like.

The method 600 may include determining 602, by use of a sensor (e.g., the sensor module 108, the sensor 212), whether a task is completed correctly. In certain embodiments, the completion determination module 302 may determine 602 whether the task is completed correctly. The method 600 may perform elements 604, 606, and 608 in response to determining that the task is completed correctly.

In some embodiments, determining 602 whether the task is completed correctly includes detecting by use of the sensor and without human intervention that the task is completed correctly. In various embodiments, determining 602 whether the task is completed correctly includes detecting using multiple sensors that the task is completed correctly. In certain embodiments, determining 602 whether the task is completed correctly includes analyzing an image obtained by the sensor to determine whether the task is completed correctly.

The sensor may include a camera, a microphone, a photosensor, a temperature sensor, a gyroscope, a meter, a switch, a proximity switch, a mechanical switch, a position sensor, and/or an optical detector. The task may include a household task such as cleaning a room, organizing the room, vacuuming the room, turning off a light, turning on the light, closing a door, opening the door, closing a window, opening the window, washing dishes, putting the dishes in a dishwasher, unloading the dishes from the dishwasher, feeding an animal, providing water to the animal, cleaning up after the animal, washing a car, vacuuming the car, cleaning the car, mowing a lawn, edging the lawn, shoveling snow, organizing a bookshelf, putting away toys, flushing a toilet, turning off an electronic device, turning on the electronic device, washing laundry, drying the laundry, and/or folding the laundry.

The method 600 may include determining 604 a user corresponding to the task. In some embodiments, the user determination module 304 may determine 604 the user corresponding to the task.

The method 600 may include changing 606 an account corresponding to the user to indicate that the task is completed correctly. In some embodiments, the account update module 306 may change 606 the account corresponding to the user to indicate that the task is completed correctly.

The method 600 may include rewarding 608 the user. In some embodiments, the reward module 308 may reward 608 the user. In certain embodiments, rewarding 608 the user includes rewarding the user with an audible sound, a financial award, a prize, points, electronic usage time, an outing, and/or the like.

In some embodiments, the method 600 includes, in response to determining that the task is not completed correctly, providing 610 an audible response to the user to indicate that the task is not completed correctly. In certain embodiments, the feedback module 402 may, in response to determining that the task is not completed correctly, provide 610 an audible response to the user to indicate that the task is not completed correctly.

In various embodiments, the method 600 may include, in response to determining that the task is not completed correctly, providing 612 training to the user to teach the user how to complete the task correctly, and the method 600 may end. In some embodiments, the training module 404 may, in response to determining that the task is not completed correctly, provide 612 training to the user to teach the user how to complete the task correctly.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a processor; and
a memory that stores code executable by the processor to:
determine, by use of a sensor, whether a task is completed correctly; and
in response to determining that the task is completed correctly:
determine a user corresponding to the task;
change an account corresponding to the user to indicate that the task is completed correctly; and
reward the user.

2. The apparatus of claim 1, wherein the sensor comprises a camera, a microphone, a photosensor, a temperature sensor, a gyroscope, a meter, a switch, a proximity switch, a mechanical switch, an optical detector, or some combination thereof.

3. The apparatus of claim 1, wherein the task comprises a household task selected from a group comprising cleaning a room, organizing the room, vacuuming the room, turning off a light, turning on the light, closing a door, opening the door, closing a window, opening the window, washing dishes, putting the dishes in a dishwasher, unloading the dishes from the dishwasher, feeding an animal, providing water to the animal, cleaning up after the animal, washing a car, vacuuming the car, cleaning the car, mowing a lawn, edging the lawn, shoveling snow, organizing a bookshelf, putting away toys, flushing a toilet, turning off an electronic device, turning on the electronic device, washing laundry, drying the laundry, and folding the laundry.

4. The apparatus of claim 1, wherein rewarding the user comprises rewarding the user with an audible sound, a financial award, a prize, points, electronic usage time, an outing, or some combination thereof.

5. The apparatus of claim 1, wherein the code executable by the processor, in response to determining that the task is not completed correctly, provides an audible response to the user to indicate that the task is not completed correctly.

6. A method comprising:
determining, by use of a sensor, whether a task is completed correctly; and
in response to determining that the task is completed correctly:
determining a user corresponding to the task;
changing an account corresponding to the user to indicate that the task is completed correctly; and
rewarding the user.

7. The method of claim 6, wherein the sensor comprises a camera, a microphone, a photosensor, a temperature sensor, a gyroscope, a meter, a switch, a proximity switch, a mechanical switch, an optical detector, or some combination thereof.

8. The method of claim 6, wherein the task comprises a household task selected from a group comprising cleaning a room, organizing the room, vacuuming the room, turning off a light, turning on the light, closing a door, opening the door, closing a window, opening the window, washing dishes, putting the dishes in a dishwasher, unloading the dishes from the dishwasher, feeding an animal, providing water to the animal, cleaning up after the animal, washing a car, vacuuming the car, cleaning the car, mowing a lawn, edging the lawn, shoveling snow, organizing a bookshelf, putting away toys, flushing a toilet, turning off an electronic device, turning on the electronic device, washing laundry, drying the laundry, and folding the laundry.

9. The method of claim 6, wherein determining whether the task is completed correctly comprises detecting by use of the sensor and without human intervention that the task is completed correctly.

10. The method of claim 6, wherein determining whether the task is completed correctly comprises detecting using a plurality of sensors that the task is completed correctly.

11. The method of claim 6, wherein determining whether the task is completed correctly comprises analyzing an image obtained by the sensor to determine whether the task is completed correctly.

12. The method of claim 6, wherein rewarding the user comprises rewarding the user with an audible sound, a financial award, a prize, points, electronic usage time, an outing, or some combination thereof.

13. The method of claim 6, further comprising, in response to determining that the task is not completed correctly, providing an audible response to the user to indicate that the task is not completed correctly.

14. The method of claim 6, further comprising, in response to determining that the task is not completed correctly, providing training to the user to teach the user how to complete the task correctly.

15. A program product comprising a computer readable storage medium that stores code executable by a processor, the executable code comprising code to perform:
determining, by use of a sensor, whether a task is completed correctly; and
in response to determining that the task is completed correctly:
determining a user corresponding to the task;
changing an account corresponding to the user to indicate that the task is completed correctly; and
rewarding the user.

16. The program product of claim 15, wherein the executable code further comprises code to perform determining whether the task is completed correctly by detecting by use of the sensor and without human intervention that the task is completed correctly.

17. The program product of claim 15, wherein the executable code further comprises code to perform determining whether the task is completed correctly by detecting using a plurality of sensors that the task is completed correctly.

18. The program product of claim 15, wherein the executable code further comprises code to perform determining whether the task is completed correctly by analyzing an image obtained by the sensor to determine whether the task is completed correctly.

19. The program product of claim 15, wherein the executable code further comprises code to perform, in response to determining that the task is not completed correctly, providing an audible response to the user to indicate that the task is not completed correctly.

20. The program product of claim 15, wherein the executable code further comprises code to perform, in response to determining that the task is not completed correctly, providing training to the user to teach the user how to complete the task correctly.
